(19) United States
(12) Patent Application Publication
(10) Pub. No.: US 2024/0280145 A1
(43) Pub. Date: Aug. 22, 2024

(54) SHAFT-HUB CONNECTION AND BRAKE ASSEMBLY HAVING A SHAFT-HUB CONNECTION

(71) Applicant: SEW-EURODRIVE GMBH & CO. KG, Bruchsal (DE)

(72) Inventors: Stefan ASCHOFF, Karlsruhe (DE); Gerolf FICHTNER-PFLAUM, Kraichtal-Unteröwisheim (DE)

(73) Assignee: SEW-EURODRIVE GMBH & CO. KG, Bruchsal (DE)

(21) Appl. No.: 18/560,812

(22) PCT Filed: Apr. 20, 2022
(86) PCT No.: PCT/EP2022/060449

§ 371 Date: Nov. 14, 2023

(30) Foreign Application Priority Data
May 17, 2021 (DE) 10 2021 002 549.0

(51) Int. Cl. F16D 3/06; F16D 55/02; F16D 65/02; F16D 65/12; F16D 65/18; F16D 121/22; H02K 5/24; H02K 7/00; H02K 7/102

(52) U.S. Cl. CPC F16D 3/06; F16D 55/02; F16D 65/123; F16D 65/186; H02K 5/24; H02K 7/003; H02K 7/1025; F16D 2065/1364; F16D 2121/22

(57) ABSTRACT

In a shaft-hub connection and brake assembly having a shaft-hub connection, a shaft has an external toothing, and a hub has an internal toothing. The hub is plugged by its internal toothing onto the shaft with external toothing such that the external toothing is in engagement with the internal toothing. The shaft has an annular groove, e.g., an annular groove, that extends around completely and/or uninterruptedly in the circumferential direction. An annular spring, e.g., a spring ring, is arranged in the annular groove, and the annular groove is arranged, e.g., centrally, in the external toothing.

### FIELD OF THE INVENTION

The present invention relates to a shaft-hub connection and brake assembly having a shaft-hub connection.

### BACKGROUND INFORMATION

In certain conventional systems, in a shaft-hub connection, the shaft is connected to the hub in a rotationally fixed manner.

A toothed coupling with a suspension, brake and system is described in German Patent Document No. 10 2011 121 790.

A centered connection arrangement is described in U.S. Pat. No. 4,136,982.

An anti-rattle arrangement is described in U.S. Pat. No. 2,800,800.

A spring brake with brake disk having friction surfaces pointing at opposite directions is described in German Patent Document No. 10 2006 010 656.

### SUMMARY

Example embodiments of the present invention provide a shaft-hub connection that can be operated with low noise.

According to example embodiments of the present invention, in a shaft-hub connection, a rotatably mounted shaft has an external toothing and a hub has an internal toothing. The hub is plugged by its internal toothing onto the shaft with an external toothing such that the external toothing is in engagement with the internal toothing. The shaft has an annular groove, e.g., an annular groove that extends around completely and/or uninterruptedly in the circumferential direction. For example, the shaft is connected to the hub in a rotationally fixed manner and is arranged displaceably in the axial direction relative to the hub. An annular spring, e.g., a spring ring, is arranged in the annular groove. The annular groove is incorporated, e.g., centrally, in the external toothing and/or the area covered by the annular groove in the axial direction includes the area covered by the external toothing in the axial direction.

Thus, a play-free shaft-hub connection is achieved by the annular spring, suppressing the noises caused by speed fluctuations. In addition, the annular spring is secured in the annular groove in a form-locking manner and is thus captively arranged. In addition, the annular spring is clampable inside the groove and is thus itself also arranged in the annular groove in play-free manner. As a result, the annular spring also does not generate any rattling noises, e.g., also not in the case of speed fluctuations.

The annular spring can also be referred to as a spring ring. However, the slope in the axial direction is a monotonically increasing function, e.g., a linear function, of the circumferential angle. Only the radial distance of the annular spring is a periodic function of the circumferential angle.

According to example embodiments, the annular spring has a maximum radial distance relative to the axis of rotation of the shaft, which distance is a variable function, e.g., a periodic function, of the circumferential angle. For example, at the local minima of the function the annular spring abuts the groove bottom of the annular groove, and the local maxima of the function are arranged in the circumferential direction between respectively two teeth of the internal toothing of the hub. Thus, the annular spring is elastically tensioned in the radial direction when the hub is pushed onto the shaft, allowing no play between the shaft and hub in the radial direction.

According to example embodiments, the annular spring is made of a metal wire, e.g., as a bent part. For example, the wire diameter of the metal wire is constant, e.g., does not depend on the circumferential angle but, for example, is a constant function of the circumferential angle. Thus, cost-effective production is achievable and the service life of the annular spring is long. In addition, operation is possible even at high temperatures. This is because metal is elastically deformable at much higher temperatures than rubber or plastic, e.g., reversibly elastically deformable.

According to example embodiments, the annular spring has a slope and/or a helix angle. Thus, the annular spring between the groove walls holds itself elastically and is thus axially captively positioned. Thus, the annular spring is clampable inside the annular groove and is thus itself also arranged in the annular groove in play-free manner. As a result, the annular spring also does not generate any rattling noises, e.g., also not in the case of speed fluctuations.

According to example embodiments, the annular spring has an increasing axial position with increasing circumferential angle, e.g., an axial position increasing proportionally to the circumferential angle. For example, the axial direction is aligned parallel to the axis of rotation of the shaft. Thus, the annular spring between the groove walls holds itself elastically and is thus axially captively positioned. Thus, the annular spring is clampable inside the annular groove and is thus itself also arranged in the annular groove in play-free manner. As a result, the annular spring also does not generate any rattling noises, e.g., also not in the case of speed fluctuations.

According to example embodiments, the annular spring is arranged elastically tensioned between the groove walls of the annular groove. Thus, the annular spring is captively arranged.

According to example embodiments, the two ends of the annular spring press into the groove bottom of the annular groove. Thus, a high static friction and stable positioning can be achieved.

According to example embodiments, the hub, e.g., the internal toothing of the hub, has a chamfer, e.g., only at its first axial end area. For example, the chamfer is configured such that the clear inner diameter, e.g., the smallest clear inner diameter, of the internal toothing increases in the axial direction with increasing distance from the first axial end of the internal toothing, e.g., proportionally to the distance from the first axial end of the internal toothing. Thus, the hub is first threaded in the push-on direction and then slides onto the annular spring when being further pushed on in the axial direction, so that the annular spring is elastically deformed radially inwardly, i.e., for example, pressed onto the groove bottom of the annular groove. The elastic spring force thus generated by the annular spring suppresses a play between the shaft and the hub.

According to example embodiments, the internal toothing and the external toothing are each arranged as a spur toothing. Thus, the shaft can be pushed axially onto the hub.

According to example embodiments, the internal toothing and the external toothing are each arranged as an involute toothing. Thus, low-cost and high-precision production is possible.

According to example embodiments, the annular spring covers a circumferential angular range of less than 360º in the circumferential direction, e.g., a circumferential angular range between 200° and 340°. Thus, a quick and ready insertion of the annular spring into the annular groove is made possible.

According to example embodiments of the present invention, in a brake assembly having a shaft-hub connection, a shaft is a tappet of a brake assembly, a hub is a brake pad carrier of a brake assembly, and the shaft is a hollow shaft part.

Thus, the brake pad carrier can be connected to the shaft with low noise, e.g., also when speed fluctuations occur during operation. Nevertheless, the brake pad carrier is arranged to be axially displaceable so that when the brake is applied or released, the brake pad carrier is axially positionable accordingly.

According to example embodiments, the tappet is plugged onto a rotor shaft of an electric motor and connected to the rotor shaft in a rotationally fixed manner, and the rotor shaft is rotatably mounted relative to a housing part of the electric motor. Thus, the rotor shaft itself does not require external toothing, but the tappet does. The rotationally fixed connection between the tappet and the rotor shaft can be achieved by a low-cost key connection.

According to example embodiments, the brake assembly has a magnetic body that is connected in a rotationally fixed manner to the housing part, e.g., to the flange part of the electric motor or to the part connected in a rotationally fixed manner to a flange part of the electric motor. An electrically energizable coil is accommodated in the magnet body, and an armature disk is connected to the magnet body in a rotationally fixed manner, e.g., in the circumferential direction, and is arranged in an axially displaceable manner relative to the magnet body, e.g., by bolts that are fixedly connected to the magnet body and project through cutouts in the armature disk. The brake pad carrier is connected to the tappet in a rotationally fixed manner, e.g., in the circumferential direction, and is arranged in an axially displaceable manner relative to the tappet. The armature disk is arranged axially between the brake pad carrier and the magnet body, spring elements supported on the magnet body press onto the armature disk, and the brake pad carrier is arranged axially between a braking surface and the armature disk. Thus, the braking effect occurs automatically in the event of a power failure, and a high level of safety can be achieved. The brake is released by energizing the coil.

According to example embodiments, the braking surface is formed on the housing part. Thus, the braking heat can be efficiently dissipated to the environment.

According to example embodiments, when the coil is energized, the armature disk is pulled toward the magnet body against the spring force generated by the spring elements, and when the coil is not energized, the spring elements push the armature disk toward the brake pad carrier so that the brake pad carrier is pressed onto the braking surface with its side facing away from the armature disk. Thus, the braking effect occurs automatically in the event of a power failure, and a high level of safety can be achieved. The brake is released by energizing the coil.

According to example embodiments, the brake pad carrier has a chamfer only at the axial end area of its internal toothing facing the armature disk. Thus, the chamfer is only necessary at the end area intended for the sliding-on.

According to example embodiments, the brake pad carrier has a chamfer only at the axial end area of its internal toothing facing away from the armature disk. Thus, the chamfer is only necessary at the end area intended for the sliding-on.

According to example embodiments, the chamfer is configured such that the clear inner diameter, e.g., the smallest clear inner diameter, of the internal toothing increases in the axial direction with increasing distance from the first axial end of the internal toothing, e.g., proportionally to the distance from the first axial end of the internal toothing. Thus, it is possible to produce the chamfer, and the radial force component of the spring force increases proportionally with the axial displacement path.

Further features and aspects of example embodiments of the present invention are explained in more detail below with reference to the appended schematic Figures.

### BRIEF DESCRIPTION OF THE DRAWINGS

FIG. 1 is a perspective view of a hub of a shaft-hub connection, e.g., of a brake assembly, the hub being arranged as a brake pad carrier.

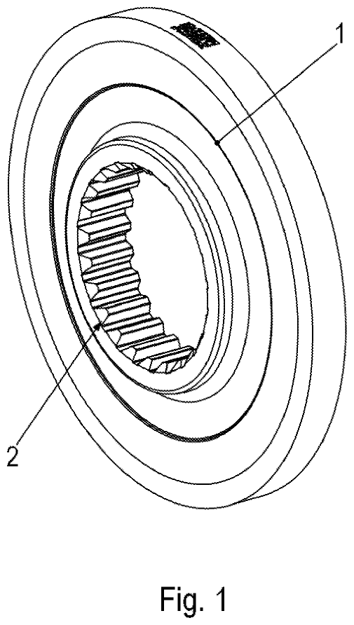

FIG. 2 is another perspective view of the hub.

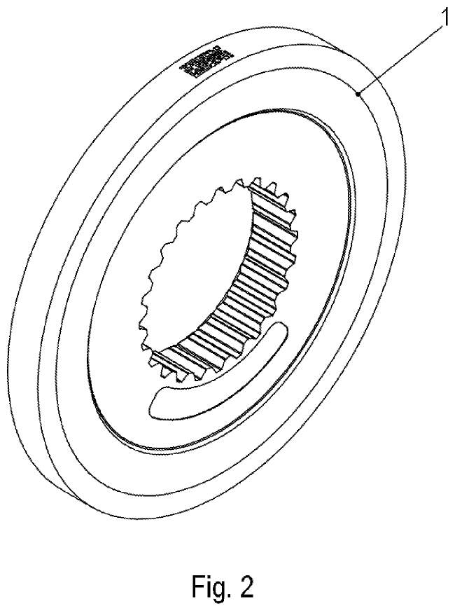

FIG. 3 is a cross-sectional view of the hub.

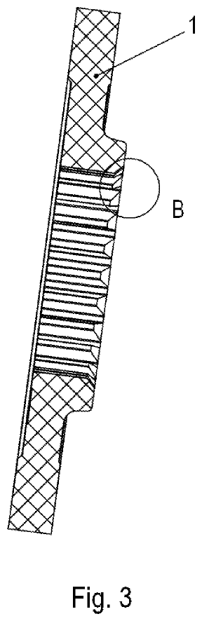

FIG. 4 is an enlarged portion B of FIG. 3.

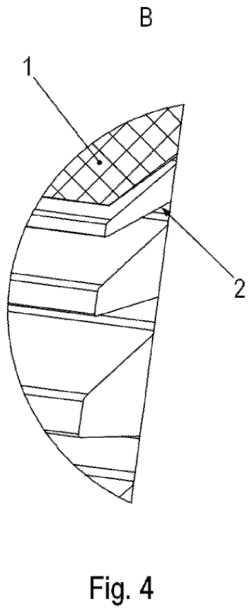

FIG. 5 is a side view of a shaft in the form of a truncated tappet 50, in whose external toothing 51 an annular spring is accommodated in a circumferential annular groove.

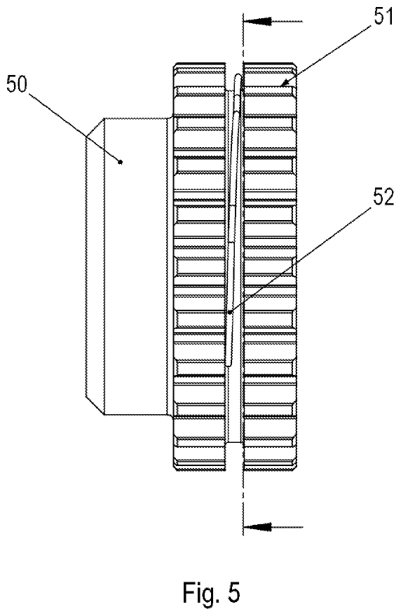

FIG. 6 is a top cross-sectional view of the shaft.

FIG. 7 is a perspective view of the annular spring 52.

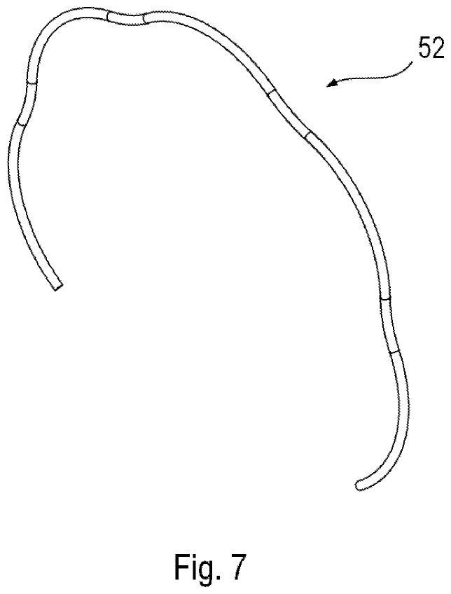

FIG. 8 is a side view of the annular spring 52.

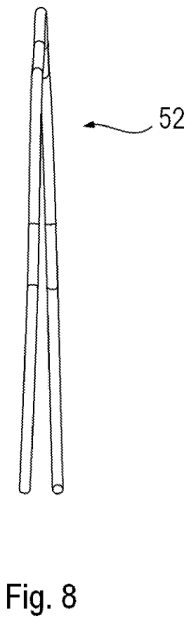

### DETAILED DESCRIPTION

As illustrated in the Figures, a shaft includes an external toothing 51 onto which a hub is plugged such that an internal toothing of the hub is in engagement with the external toothing 51 and thus the hub is axially movable but connected to the shaft in a form-locking manner in the circumferential direction. Within the external toothing 51, an annular groove is arranged, e.g., centrally in the axial direction within the external toothing and extending completely around in the circumferential direction. An annular spring 52 is accommodated in the annular groove.

The annular spring 52 is made of a metal wire and is not arranged to extend completely around in the circumferential direction.

The annular spring 52 covers a circumferential angular range of less than 360° in the circumferential direction, e.g., a circumferential angular range between 200° and 340°.

The annular spring 52 has, e.g., a maximum radial distance which varies periodically and/or is changeable in dependence on the circumferential angle.

The wire diameter is substantially constant along the annular spring 52.

The annular spring 52 has a non-vanishing slope so that the axial position of the annular spring increases with increasing circumferential angle. This provides for elastic clamping between the groove walls formed on the annular groove in the axial direction and against the axial direction.

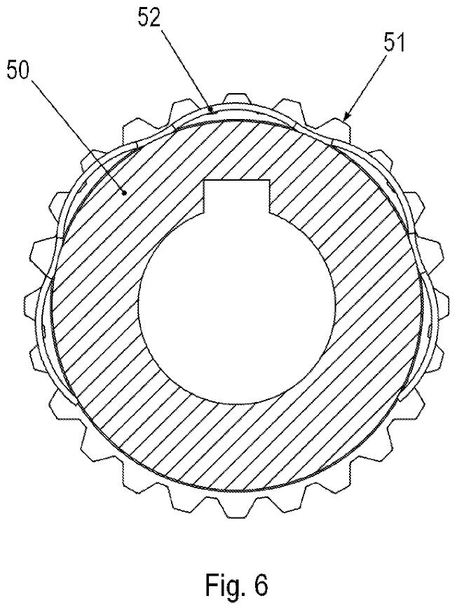

In addition, the two ends of the annular spring 52 press radially inwardly onto the groove bottom of the annular groove, as illustrated in FIG. 6. Thus, improved adhesion of the annular spring 52 to the shaft is achieved.

When the hub is plugged with its internal toothing axially onto the external toothing 51, a chamfer 2 formed on the hub allows the radially inward projecting teeth of the internal toothing to slide onto the annular spring 52. In the process, the annular spring 52 is pressed radially inwardly, e.g., toward the groove bottom of the annular groove. The annular spring 52 is elastically tensioned and generates a spring force correspondingly acting radially outwardly, which is introduced into the hub.

Thus, the hub is connected to the shaft in a form-locking manner in the circumferential direction and the shaft is arranged displaceably in the axial direction relative to the hub. The radially directed play is eliminated by the elastically tensioned annular spring 52.

As a result of the elastically pretensioned contact of the annular spring 52 against both groove walls of the annular groove, the annular spring 52 is arranged in the annular groove without play.

In an exemplary application of the shaft-hub connection described herein, the hub is arranged as a brake pad carrier 1 of an electromagnetically operable brake assembly and the shaft is arranged as a tappet 50 of the brake assembly.

The tappet 50 is arranged as an externally toothed hollow shaft and is plugged onto a rotor shaft of an electric motor and connected to the rotor shaft in a rotationally fixed manner, e.g., by a key connection.

The external toothing of the tappet 50 is, for example, arranged as a knurling or as an axially directed involute toothing, i.e., an involute toothing having the helix angle zero.

The radial distance range covered by the annular spring 52 includes the radial distance range covered by the teeth of the external toothing 51. Thus, the teeth protrude radially beyond the annular spring 52. Alternatively, the annular groove on the tappet 50 is cut radially deeper than the toothing so that the radial distance range covered by the annular spring 52 overlaps with the radial distance range covered by the teeth of the external toothing 51.

The chamfer 2 is arranged on only one of the two axial end areas of the internal toothing of the brake pad carrier 1. Thus, for example, the plug-on direction for plugging the brake pad carrier 1 onto the tappet 50 is predetermined.

The brake pad carrier 1 has a brake pad axially on both sides.

The rotor shaft is rotatably mounted by bearings, which are accommodated in flange parts, which are connected to the stator housing of the electric motor.

The brake assembly has a braking surface which is either formed on one of the flange parts itself, e.g., finely machined, or on a part connected to a first one of the flange parts.

A magnet body of the brake assembly is connected to the part or flange part in a rotationally fixed manner.

A coil, e.g., arranged as a ring winding, is accommodated in the magnet body. For this purpose, an annular or pot-shaped cutout is, for example, made in the magnet body, in which the coil is inserted and cast in casting compound.

The ring axis of the ring winding is aligned parallel to the axial direction.

An armature disk is connected to the magnet body in a rotationally fixed manner and arranged in an axially displaceable manner. For example, axially aligned bolts are connected to the magnet body for this purpose, which protrude through corresponding cutouts in the armature disk. In this manner, by the bolts, the magnetic body can be connected to the part or to the flange part.

The armature disk is made of ferromagnetic material.

The armature disk is arranged between the magnet body in the axial direction. The brake pad carrier 1 is arranged in the axial direction between the braking surface and the armature disk.

Elastically deformed spring elements supported on the magnet body press on the armature disk.

Thus, when the coil is energized, the armature disk is pulled toward the magnet body against the spring force generated by the spring elements. Thus, the brake pad carrier 1 is detached and the brake assembly is released.

In addition, when the coil is not energized, the spring elements push the armature disk away from the magnet body towards the brake pad carrier, which is thus pressed onto the braking surface on its side facing away from the armature disk, and the brake assembly thus engages, e.g., it thus introduces a braking torque into the rotor shaft.

The annular spring 52 can also be referred to as a spring ring.

According to example embodiments, in the case of the chamfer 2, the minimum radial distance of the internal toothing of the brake pad carrier does not increase linearly with the axial position, as in the example embodiment illustrated in the Figures, but rather the chamfer 2 has a curved configuration. Thus, the internal toothing achieves a longer service life, especially in the area of the chamfer.

### LIST OF REFERENCE NUMERALS

1 Brake pad carrier
2 Chamfer
50 Tappet
51 External toothing
52 Annular spring

1-15. (canceled)

16. A shaft-hub connection, comprising:
a shaft including an external toothing and an annular groove;
a hub including an internal toothing, the shaft being inserted into the hub, the external toothing of the shaft being engaged with the internal toothing of the hub;
an annular spring arranged in the annular groove;
wherein the annular groove is arranged in the external toothing of the shaft and/or an area covered by the annular groove in an axial direction of the shaft is included in an area covered by the external toothing in the axial direction.

17. The shaft-hub connection according to claim 16, wherein the shaft is connectable to the hub in a rotationally fixed and axially displaceable manner.

18. The shaft-hub connection according to claim 16, wherein the annular groove extends completely around and/or uninterruptedly in a circumferential direction of the shaft.

19. The shaft-hub connection according to claim 16, wherein the annular spring is arranged as a spring ring.

20. The shaft-hub connection according to claim 16, wherein the annular groove is arranged centrally in the external toothing of the shaft.

21. The shaft-hub connection according to claim 16, wherein the annular spring has a maximum radial distance relative to an axis of rotation of the shaft, the radial distance being a variable function of circumferential angle.

22. The shaft-hub connection according to claim 21, wherein the radial distance is a periodic function of the circumferential angle.

23. The shaft-hub connection according to claim 21, wherein at local minima of the function, the annular spring abuts a groove bottom of the annular groove.

24. The shaft-hub connection according to claim 21, wherein each local maxima of the function is arranged in the circumferential direction between two teeth of the internal toothing of the hub.

25. The shaft-hub connection according to claim 16, wherein the annular spring is made of a metal wire.

26. The shaft-hub connection according to claim 25, wherein the annular spring is arranged as a bent part.

27. The shaft-hub connection according to claim 25, wherein a wire diameter of the metal wire is constant.

28. The shaft-hub connection according to claim 16, wherein the annular spring has a slope and/or a helix angle.

29. The shaft-hub connection according to claim 16, wherein the annular spring has an increasing axial position with increasing circumferential angle.

30. The shaft-hub connection according to claim 29, wherein the axial position of the annular spring increases proportionally to the circumferential angle.

31. The shaft-hub connection according to claim 29, wherein the axial direction is aligned parallel to an axis of rotation of the shaft.

32. The shaft-hub connection according to claim 16, wherein the annular spring is arranged elastically tensioned between groove walls of the annular groove.

33. The shaft-hub connection according to claim 16, wherein two ends of the annular spring press into a groove bottom of the annular groove.

34. The shaft-hub connection according to claim 16, wherein the hub and/or the internal toothing of the hub includes a chamfer.

35. The shaft-hub connection according to claim 34, wherein the chamfer is located only at a first axial end area of the hub.

36. The shaft-hub connection according to claim 34, wherein the chamfer is arranged such that a clear inner diameter and/or a smallest clear inner diameter of the internal toothing increases in the axial direction with increasing distance from a first axial end of the internal toothing and/or proportionally to the distance from the first axial end of the internal toothing.

37. The shaft-hub connection according to claim 16, wherein the internal toothing and the external toothing are arranged as spur toothings and/or involute toothings.

38. The shaft-hub connection according to claim 16, wherein the annular spring covers a circumferential angular range of less than 360° in a circumferential direction.

39. The shaft-hub connection according to claim 38, wherein the annular spring covers a circumferential angular range between 200° and 340°.

40. A brake assembly, comprising:
a shaft-hub connection as recited in claim 16;
wherein the shaft is arranged as a tappet of the brake assembly and the hub is arranged as a brake pad carrier of the brake assembly; and
wherein the shaft is arranged as a hollow shaft part.

41. The brake assembly according to claim 40, wherein the tappet is arranged on a rotor shaft of an electric motor and connected to the rotor shaft in a rotationally fixed manner, and the rotor shaft is rotatably mounted relative to a housing part of the electric motor.

42. The brake assembly according to claim 40, further comprising:
a magnetic body connected in a rotationally fixed manner to the housing part;
an electrically energizable coil accommodated in the magnetic body; and
an armature disk connected to the magnetic body in a rotationally fixed manner and arranged in an axially displaceable manner relative to the magnetic body;
wherein the brake pad carrier is connected to the tappet in a rotationally fixed manner and is arranged in an axially displaceable manner relative to the tappet;
wherein the armature disk is arranged axially between the brake pad carrier and the magnetic body;
wherein spring elements supported on the magnetic body press onto the armature disk; and
wherein the brake pad carrier is arranged axially between a braking surface and the armature disk.

43. The brake assembly according to claim 42, wherein the magnetic body is connected in a rotationally fixed manner to a flange part of the electric motor and/or to a part connected in a rotationally fixed manner to the flange part of the electric motor, the armature disk is connected to the magnetic body in a rotationally fixed manner in the circumferential direction and is arranged in an axially displaceable manner relative to the magnetic body by bolts that are fixedly connected to the magnetic body and project through cutouts in the armature disk, the brake pad carrier is connected to the tappet in a rotationally fixed manner in the circumferential direction.

44. The brake assembly according to claim 42, wherein the braking surface is formed on the housing part.

45. The brake assembly according to claim 42, wherein the coil is adapted to be energized to pull the armature disk toward the magnet body against a spring force generated by the spring elements, and the coil is adapted to be deenergized to push the armature disk by the spring elements toward the brake pad carrier so that the brake pad carrier is pressed onto the braking surface with a side facing away from the armature disk.

46. The brake assembly according to claim 42, wherein the brake pad carrier has a chamfer only at an axial end area of the internal toothing facing the armature disk or facing away from the armature disk.

47. The brake assembly according to claim 46, the chamfer is arranged such that a clear inner diameter and/or a smallest clear inner diameter of the internal toothing increases in an axial direction with increasing distance from the first axial end of the internal toothing and/or proportionally to a distance from the first axial end of the internal toothing.
